(19) United States
(12) Patent Application Publication
(10) Pub. No.: US 2006/0292937 A1
(43) Pub. Date: Dec. 28, 2006

(54) Electrical connector having dual contact function spring contact terminal

(76) Inventors: John R. Morello, Warren, OH (US); Thomas Gilbert Morello, Cortland, OH (US); William G. Strang, Warren, OH (US)

Correspondence Address: DELPHI TECHNOLOGIES, INC., M/C 480-410-202, PO BOX 5052, TROY, MI, 48007, US

(21) Appl. No.: 11/159,909

(22) Filed: Jun. 23, 2005

(51) Int. Cl. H01R 13/11

(52) U.S. Cl. 439/856

(57) ABSTRACT

An electrical connector including an electrical conductor body having disposed therewithin at least one dual contact function spring contact terminal. Each dual contact function spring contact terminal is characterized by an arm which originates at a primary nose of the electrical conductor body, whereat an arm bends 180 degrees forming an initial arm portion. A primary spring is connected to the initial arm portion and connects to a contact portion of the arm. A secondary nose is connected to the contact portion, whereat the arm bends 180 degrees. A secondary spring is connected to the secondary nose, the secondary spring carries an arm terminus which abuts the electrical conductor body, preferably at a relief spring. The primary and secondary springs function independently to provide resilient location of the contact portion independently of each other.

### TECHNICAL FIELD

The present invention relates to electrical connectors, and more particularly to female connectors having a spring contact for electrically interfacing a male blade terminal. Still more particularly, the present invention relates to an electrical connector having a dual contact function spring contact.

### BACKGROUND OF THE INVENTION

In the electrical arts, it has been the practice to provide a selectively separable electrical connection between first and second electrical circuits by mutually interfacing first and second electrical connectors, each being respectively connected to the first and second electrical circuits. In this regard, of particular interest are box-shaped electrical connectors having an internally disposed resilient spring contact terminal for engaging a male mating blade connector when the latter is inserted into the electrical connector. An interesting example of such an electrical connector is recounted in U.S. Pat. No. 5,281,175.

Electrical connectors having spring contact terminals perform well to provide electrical connection with respect to an inserted male blade terminal; however, certain deficiencies are present. For example, should the spring contact terminal become deformed (as for example because a male blade terminal was, itself, bent and then insertionally forced so as to thereby cause the deformation), then there is some likelihood that the electrical connection between the spring contact terminal and the male blade terminal will fail.

Accordingly, it would be most desirable if an electrical connector could be devised wherein the spring contact terminal thereof could be insensitive to deformation by somehow providing a dual contact function to the spring terminal contact.

### SUMMARY OF THE INVENTION

The present invention is an electrical connector having disposed therewithin a spring contact terminal which is insensitive to deformation by providing a dual contact function thereto.

The improved electrical connector according to the present invention includes an electrical conductor body having a general box-shape terminal cavity defined by an upper wall, a lower wall and a pair of sidewalls, wherein internally disposed is at least one dual contact function spring contact terminal.

A dual contact function spring contact terminal originates at a primary nose formed integrally of either the upper or the lower wall, at the entry port of the electrical conductor body. At the primary nose, an arm is integrally formed of the conductor body which bends 180 degrees so as to form an initial arm portion disposed within the terminal cavity and extending, in spaced relation from the subject upper or lower wall, rearwardly from the primary nose in parallel relation to the subject upper or lower wall. A contact portion of the arm is generally medially disposed within the terminal cavity via a primary spring of the arm which spans between the initial portion and a forward end of the contact portion of the arm. At the opposite, rearward end of the contact portion of the arm is a secondary nose formed of the arm so as to provide a 180 degree bend therein. Connected to the secondary nose is a secondary spring of the arm which bends toward, and contacts, at a terminus thereof, the subject upper or lower wall. Disposed in opposition to the contact portion of the arm is a terminal contact formed of the electrical conductor body (this may be alternatively in another embodiment, simply the contact portion of the arm of another dual contact function spring contact terminal).

In operation, a male blade terminal is inserted into the electrical conductor body of the electrical connector, wherein, as the male blade terminal is inserted, it abuts the primary spring and the opposing terminal contact, causing the primary spring to resiliently bend toward the subject upper or lower wall. As insertion of the male blade terminal continues, the male blade terminal slides further along the contact portion of the arm and the opposing terminal contact, and the secondary spring also becomes resiliently bent toward the subject upper or lower wall. Upon full insertion of the male blade terminal, the male blade terminal is in good electrical contact with the contact portion of the arm and the terminal contact as a result of the dual spring action of the primary and secondary springs.

The primary spring and the secondary spring perform independently of each other. Accordingly, in the event the primary spring should become damaged, as for example if the male blade terminal untowardly bent the primary spring, then the secondary spring will function normally and independently of the primary spring so as to provide excellent electrical contact of an inserted male blade terminal with the contact portion of the arm and the opposing terminal contact.

To provide better facilitation of various thicknesses of male blade terminals, it is preferred to include a relief spring formed in the subject upper or lower wall where the arm terminus abuts the subject upper or lower wall. In this regard, if a male blade terminal thicker than a predetermined thickness is inserted into the conductor body cavity, the incremented secondary spring tension is relieved by resilient bending of the relief spring.

In another, preferred form of the present invention (mentioned briefly hereinabove), a pair of dual contact function spring contact terminals is provided. An upper dual contact function spring contact terminal is formed of an upper arm via an upper primary nose, and a lower dual contact function spring contact terminal is formed of a lower arm via a lower primary nose, wherein the upper and lower arms are mirrors of each other.

Accordingly, it is an object of the present invention to provide an electrical connector having disposed therewithin at least one dual contact function spring contact terminal, wherein primary and secondary springs thereof function independently of each other.

This and additional objects, features and advantages of the present invention will become clearer from the following specification of a preferred embodiment.

### BRIEF DESCRIPTION OF THE DRAWINGS

FIG. 1 is a perspective view of an electrical connector body having disposed therewithin a pair of dual contact function spring contact terminals according to the present invention.

FIG. 2 is a front end view of the electrical connector of FIG. 1.

FIG. 3 is a sectional view of the electrical connector of FIG. 1, seen along line 3-3 of FIG. 2.

FIG. 4 is a sectional view of the electrical connector as in FIG. 3, now seen in operation with respect to an inserted male blade terminal.

FIG. 5 is a sectional view of the electrical connector in operation as in FIG. 4, wherein now a male blade terminal thicker than a predetermined thickness has been inserted.

FIG. 6 is a sectional view of the electrical connector in operation as in FIG. 4, wherein now the primary spring of the lower dual function spring contact terminal has been damaged.

FIG. 7 is a sectional view of an alternative embodiment of the electrical connector according to the present invention, wherein a single dual function spring terminal is provided.

FIG. 8 is a sectional view of the electrical connector as in FIG. 7, now seen in operation with respect to an inserted male blade terminal.

FIG. 9 is a sectional view of the electrical connector in operation as in FIG. 7, wherein now a male blade terminal thicker than a predetermined thickness has been inserted.

FIG. 10 is a sectional view of the electrical connector in operation as in FIG. 7, wherein now the primary spring of the dual function spring contact terminal has been damaged.

### DESCRIPTION OF THE PREFERRED EMBODIMENT

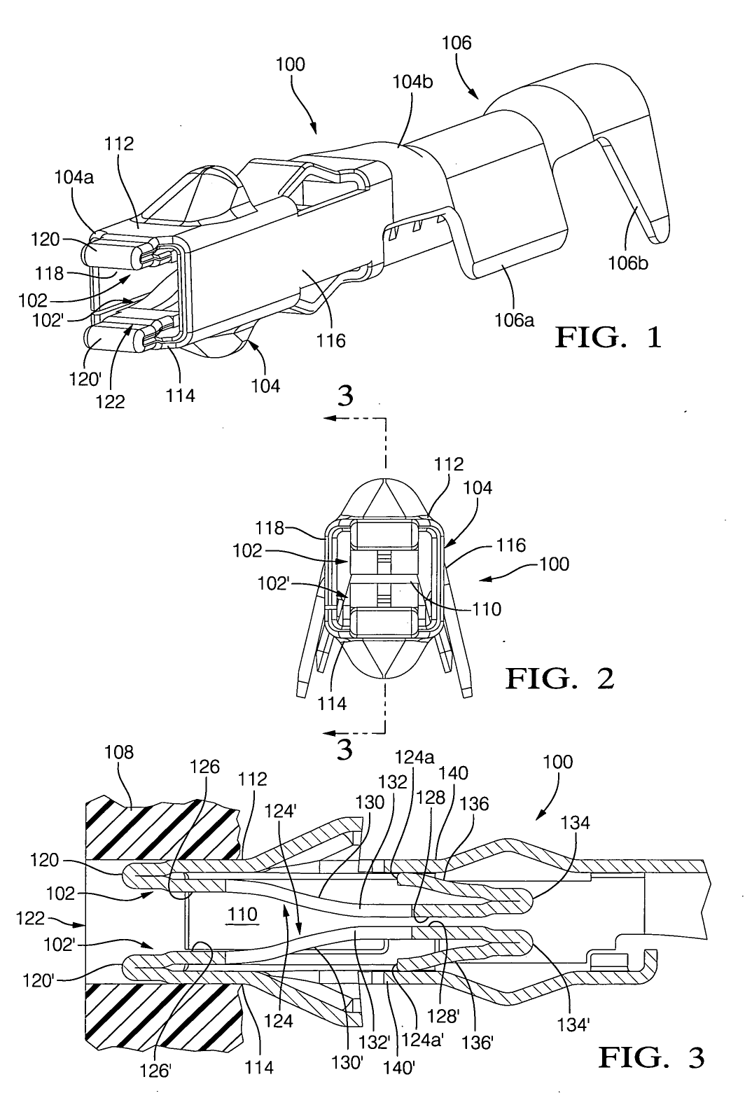

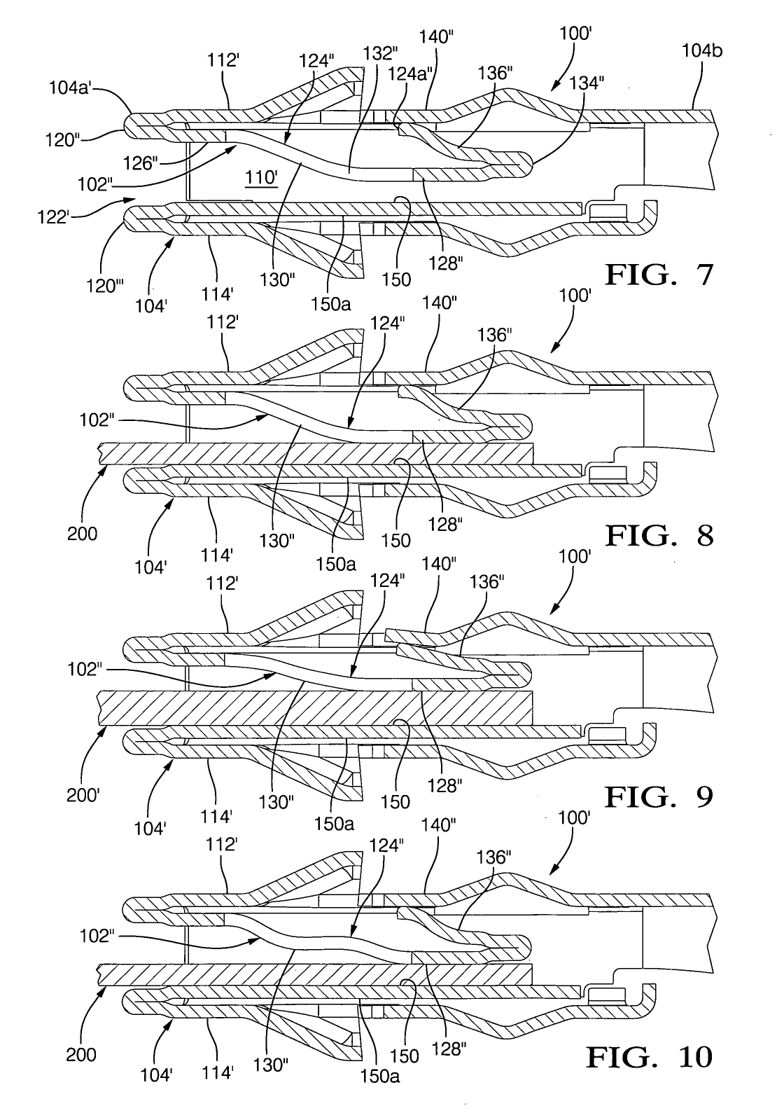

Referring now to the Drawing, FIGS. 1 through 6 depict aspects of a first embodiment, and FIGS. 7 through 10 depict aspects of a second embodiment, of an electrical connector 100, 100′ having disposed therewithin at least one dual function contact spring terminal 102, 102′, 102″ according to the present invention.

Referring now to the first embodiment depicted at FIGS. 1 through 6, the electrical connector 100 is composed of a preferably (but not necessarily) single piece, metal sheet which is stamped to provide an electrical conductor body 104 having a forward end 104a and a rearward end 104b and, integrally connected to the rearward end, a wiring engagement member 106 including a bare wire crimp portion 106a and a wire jacket crimp portion 106b. The electrical conductor body 104 is encapsulated in a plastic or other suitable insulator 108 in a manner known in the art, a portion of which is shown by way of example at FIG. 3.

The electrical conductor body 104 has a general box-shape, forming therewithin a terminal cavity 110 defined by an upper wall 112, an oppositely disposed lower wall 114 and a pair of mutually opposed sidewalls 116, 118, wherein internally disposed are upper and lower dual contact function spring contact terminals 102, 102′.

The upper dual contact function spring contact terminal 102 is composed of an upper arm 124 originating at an upper primary nose 120 that is formed integrally of the upper wall 112 at an entry port 122 of the electrical conductor body 104. At the upper primary nose 120, the upper arm 124 is integrally formed of the electrical conductor body 104 which bends 180 degrees so as to form an initial upper arm portion 126 disposed within the terminal cavity 110 and extending, in close spaced relation from the upper wall 112, rearwardly from the upper primary nose in parallel relation to the upper wall.

An upper contact portion 128 of the upper arm 124 is generally medially disposed within the terminal cavity 110 via an upper primary spring 130 of the upper arm which spans between the initial upper arm portion 126 and a forward end of the upper contact portion 128 of the upper arm. Resiliency of the upper primary spring 130 may be enhanced by preferably providing a centrally disposed upper primary spring slot 132 formed thereat in the upper arm.

At the opposite, rearward end of the upper contact portion 128 of the upper arm 124 is an upper secondary nose 134 formed of the upper arm so as to provide a 180 degree bend therein. Extending from the upper secondary nose 134 is an upper secondary spring 136 of the upper arm which bends toward, and contacts at an upper arm terminus 124a of the upper arm, the upper wall 112. Resiliency of the upper secondary spring 136 may be adapted to suit a particular application, if desired, by providing a centrally disposed upper secondary spring slot or by widening or narrowing the upper arm thereat.

To provide better facilitation of various thicknesses of male blade terminals (as discussed further hereinbelow), it is preferred to include an upper relief spring 140 formed in the upper wall 112 where the upper arm terminus 124a abuts the upper wall. In this regard, if a male blade terminal thicker than a predetermined thickness is inserted into the conductor body cavity, then the incremented secondary spring tension is relieved by resilient bending of the upper relief spring.

The lower dual contact function spring contact terminal 102′ is composed of a lower arm 124′ originating at a lower primary nose 120′ formed integrally of the lower wall 114 at the entry port 122 of the electrical conductor body 104. At the lower primary nose 120′, the lower arm 124′ is integrally formed of the conductor body 104 which bends 180 degrees so as to form an initial lower arm portion 126′ disposed within the terminal cavity 110 and extending, in closely spaced relation from the lower wall 114, rearwardly from the lower primary nose in parallel relation to the lower wall.

A lower contact portion 128′ of the lower arm 124′ is generally medially disposed within the terminal cavity 110 via a lower primary spring 130′ of the lower arm which spans between the initial lower arm portion 126′ and a forward end of the lower contact portion 128′ of the lower arm. The upper and lower contact portions 128, 128′ are disposed in mutually opposing relation. Resiliency of the lower primary spring 130′ may be enhanced by preferably providing a centrally disposed lower primary spring slot 132′ formed thereat in the lower arm.

At the opposite, rearward end of the lower contact portion 128′ of the lower arm 124′ is a lower secondary nose 134′ formed of the lower arm so as to provide a 180 degree bend therein. Extending from the lower secondary nose 134′ is a lower secondary spring 136′ of the lower arm which bends toward, and contacts at the lower arm terminus 124a′ of the lower arm, the lower wall 114. Resiliency of the lower secondary spring 136′ may be adapted to suit a particular application, if desired, by providing a centrally disposed upper secondary spring slot or by widening or narrowing the lower arm thereat.

To provide better facilitation of various thicknesses of male blade terminals (as discussed further hereinbelow), it is preferred to include a lower relief spring 140′ formed in the lower wall 114 where the lower arm terminus 124a′ abuts the lower wall. In this regard, if a male blade terminal thicker than a predetermined thickness is inserted into the conductor body cavity, then the incremented secondary spring tension is relieved by resilient bending of the lower relief spring.

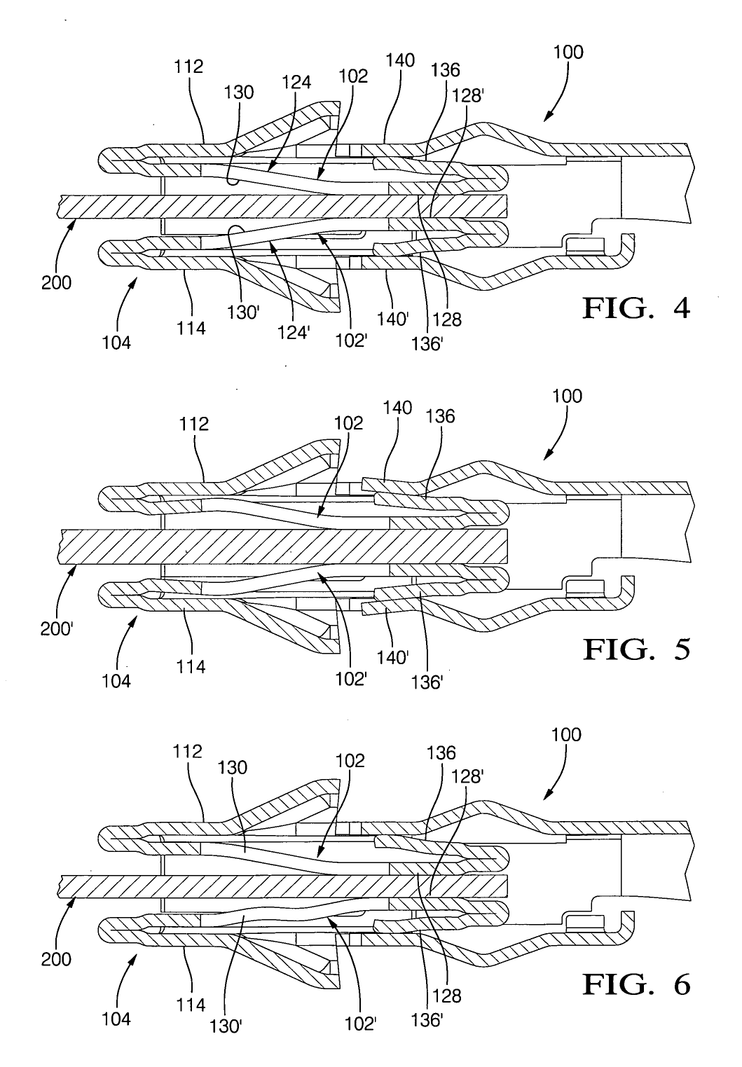

Referring now additionally to FIGS. 4 through 6, various operational aspects of the electrical connector 100 will be discussed.

Referring firstly to FIG. 4, a male blade terminal 200 is inserted into the electrical conductor body 104 of the electrical connector, wherein, as the male blade terminal is inserted, it abuts with the upper and lower primary springs 130, 130′, causing the upper primary spring to resiliently bend toward the upper wall 110, and the lower primary spring to resiliently bend toward the lower wall 112. As insertion continues, the male blade terminal slides along the upper contact portion 128 of the upper arm 124 and the lower contact portion 128′ of the lower arm 124′, the upper secondary spring 136 is resiliently bent toward the upper wall 112 and the lower secondary spring 136′ is resiliently bent toward the lower wall 114. Upon full insertion of the male blade terminal, as shown at FIG. 4, the independent and dual spring action of the upper and lower primary springs and upper and lower secondary springs, the male blade terminal is in good electrical contact with the upper and lower contact portions, which conform to the male blade terminal, and, consequently, with the electrical conductor body 104. In this regard, the upper primary spring 130 and upper secondary spring 136 of the upper dual contact function spring contact terminal 102 perform independently of each other to resiliently locate the upper contact portion 128 of the upper arm 124; and likewise, the lower primary spring 130′ and lower secondary spring 136′ of the lower dual contact function spring contact terminal 102′ perform independently of each other to resiliently locate the lower contact portion 128′ of the lower arm 124′.

To provide better facilitation of various thicknesses of male blade terminals, the upper and lower relief springs 140, 140′ deform when a male blade terminal greater than a predetermined thickness is inserted into the electrical connector in order to prevent over forcing of the upper and lower secondary springs 136, 136′. For example, if the male blade terminal 200 of FIG. 4 has a predetermined male blade thickness of 0.64 mm. But now, as shown at FIG. 5, if a male blade terminal 200′ having a thickness of 0.80 mm. is inserted into the conductor body cavity, then the incremented upper and lower secondary spring tensions are relieved by resilient bending of the upper and lower relief springs 140, 140′.

In the event one of the upper and lower primary springs 130, 130′ should become damaged, or both become damaged for that matter, then its respective still undamaged upper or lower secondary spring 136, 136′ will function normally and independently of the damaged upper or lower primary spring so as to continue to provide excellent electrical contact of inserted male blade terminal with the upper and lower dual contact function spring contact terminals 102, 102′, and, as a consequence, with the electrical conductor body 104. As shown by way of example at FIG. 6, the primary spring 130′ of the lower dual contact function spring contact terminal 102′ has been bendingly damaged by some untoward event, yet the lower secondary spring 136′ is independently and normally functioning to provide good electrical contact of the male blade terminal 200 with the upper and lower contact portions 128, 128′ and, consequently, with the electrical conductor body 104.

Referring now to the second embodiment depicted at FIGS. 7 through 10, the electrical connector 100′ is composed of a preferably (but not necessarily) single piece of metal sheet which is stamped to provide an electrical conductor body 104′ having a forward end 104a′ and a rearward end 104b′ and, integrally connected to the rearward end, a wiring engagement member which, although not shown in FIGS. 7 through 10, is identical to that shown as 106 in FIG. 1 and includes the aforedescribed bare wire crimp portion 106a and a wire jacket crimp portion 106b. The electrical conductor body 104′ is encapsulated in a plastic or other suitable insulator in a manner known in the art (depicted by way of example at FIG. 3).

The electrical conductor body 104′ has a general box-shape, forming therewithin a terminal cavity 110′ defined by an upper wall 112′, an oppositely disposed lower wall 114′ and a pair of mutually opposing sidewalls 116′, 118′, wherein internally disposed is a single dual contact function spring contact terminal 102″ integral with the upper wall 112′. A terminal contact 150 is formed in the terminal cavity 100′ in integral connection to the lower wall 114′ and in opposite disposition relative to the dual contact function spring contact terminal 102″. It is to be understood that the dual contact function spring contact terminal 102″ shown in FIGS. 7 through 10 is connected to the upper wall 112′ merely be way of exemplification, since the lower wall 114′ is equally usable therefor (analogously to the lower dual contact function spring contact terminal 102′ discussed hereinabove).

The dual contact function spring contact terminal 102″ is composed of an arm 124″ originating at a primary nose 120′ formed integrally of the upper wall 112′ at an entry port 122′ of the electrical conductor body 104′. At the primary nose 120″, the arm 124″ is integrally formed of the conductor body 104′ which bends 180 degrees so as to form an initial arm portion 126″ disposed within the terminal cavity 110′ and extending, in closely spaced relation from the upper wall 112′, rearwardly from the primary nose in parallel relation to the upper wall.

A contact portion 128″ of the arm 124″ is generally medially disposed within the terminal cavity 110′ via a primary spring 130″ of the arm which spans between the initial arm portion 126″ and a forward end of the contact portion 128″ of the arm. Resiliency of the primary spring 130″ may be enhanced by a preferably provided centrally disposed primary spring slot 132″ formed thereat in the arm.

At the opposite, rearward end of the contact portion 128″ of the arm 124″ is a secondary nose 134″ formed of the arm so as to provide a 180 degree bend therein. Extending from the secondary nose 134″ is a secondary spring 136″ of the arm which bends toward, and contacts at the arm terminus 124a″ of the arm, the upper wall 112′. Resiliency of the secondary spring 136″ may be adapted to suit a particular application, if desired, by providing a centrally disposed upper secondary spring slot or by widening or narrowing the arm thereat.

To provide better facilitation of various thicknesses of male blade terminals (as discussed further hereinbelow), it is preferred to include a relief spring 140″ formed in the upper wall 112′ where the arm terminus 124a″ abuts the upper wall. In this regard, if a male blade terminal thicker than a predetermined thickness is inserted into the conductor body cavity, then the incremented secondary spring tension is relieved by resilient bending of the relief spring 140″.

The terminal contact 150 is disposed within the connector cavity opposite the dual function spring terminal. The terminal contact 150 is composed of a second arm 150a originating at a second nose 120′″ formed integrally of the lower wall 114″ at the entry port 122′ of the electrical conductor body 104′ and extends rearwardly therefrom. The terminal contact 150 is opposingly disposed relative to the contact portion 128″.

Various aspects of operation of the electrical conductor 100′ will now be discussed.

As shown at FIG. 8, a male blade terminal 200 is inserted into the electrical conductor body 104′ of the electrical connector, wherein, as the male blade terminal is inserted, it abuts the primary spring 130″ and the opposingly disposed terminal contact 150, causing the primary spring to resiliently bend toward the upper wall. As insertion of the male blade terminal continues, and the male blade terminal slides along the contact portion 128″ of the arm 124″ and along the terminal contact 150, the secondary spring 136″ is resiliently bent toward the upper wall 112′. Upon full insertion of the male blade terminal, as shown at FIG. 8, the independent and dual spring action of the primary spring 130″ and the secondary spring 136″ provide the male blade terminal with good electrical contact with the contact portion 128″ (which conforms to the male blade terminal) and the terminal contact 150, and consequently, to the electrical body 104′. In this regard, the primary spring 130″ and the secondary spring 136″ perform independently of each other to resiliently locate the contact portion 128″ of the arm 124″.

To provide better facilitation of various thicknesses of male blade terminals, the relief spring 140″ deforms when a male blade terminal thicker than a predetermined thickness is inserted into the electrical connector in order to prevent over forcing of the secondary spring. FIG. 9 depicts an example wherein the male blade terminal 200 of FIG. 7 has a predetermined thickness of 0.64 mm. But, if now a male blade terminal 200′ having a thickness of 0.80 mm. is inserted into the conductor body cavity, the incremented secondary spring tension is relieved by resilient bending of the relief spring 140″.

In the event the primary spring 130″ should become damaged, as for example by being bent as shown at FIG. 10, then the undamaged secondary spring 136″ will function normally and independently of the damaged primary spring so as to provide excellent electrical contact of the inserted male blade terminal 200 with the contact portion 128″ and the terminal contact 150, and consequently, with the electrical connector body 104′.

With respect to the foregoing exemplary description of the preferred embodiments 100 100′, it will be understood that a number of advantages pertain to the present invention, including:

The primary and secondary springs of each dual contact function spring contact terminal provide resilient location of the contact portion of the arm independent of each other.

Various thicknesses of male blade terminals are accommodated, which eliminates need for different sized electrical connectors for differing sized male blade terminals.

The configuration of the dual contact function spring contact terminals is robust with respect to accommodation of misaligned male blade terminals, is tolerance insensitive, and obviates the need for lubricants.

The spring stiffness of the dual contact function spring contact terminals can be easily modified using the same basic shape so as to achieve desired engagement and normal force properties.

An electrical conductor can be made using any number of dual contact function spring contact terminals.

The terminal contact will compliantly follow the surface movement of the male blade terminal, and the electrical contact therebetween is vibration insensitive.

Over-stress of the dual contact function spring contact terminals is prevented by operation of the relief springs. In this regard, the relief springs provide a substantial constancy to the normal forces over a range of male blade terminal thicknesses. The normal force increases during the insertion process of the male blade terminal, accordingly, a low engagement force occurs, while yet a high normal force is provided. In this regard, the normal force is primarily provided by the secondary spring and the secondary nose. In simulation testing, a failure of the primary spring does not cause failure of the normal force, as the secondary spring carries most of the load. By way of exemplification using an electrical connector 100, a 0.64 mm. thick male blade terminal may have a maximum engagement force of 2.35 N and a maximum normal (contact) force of 7.0 N, whereas a 0.80 mm. thick male blade terminal may have a maximum engagement force of 3.45 N and a maximum normal (contact) force of 8.4 N; it is seen in this example that the difference in thickness results in an approximately 1.4 Newton normal force difference.

The dual contact function spring contact terminals may be utilized with symmetric or non-symmetric male blade terminals (non-symmetric possibly providing a reduced size dual contact function spring contact terminal). The dual contact function spring contact terminal is robust with regard to non-conforming male blade terminals vis-a-vis the primary nose and compliancy of the contact portion thereof with respect to an inserted male blade terminal.

To those skilled in the art to which this invention appertains, the above described preferred embodiment may be subject to change or modification. Such change or modification can be carried out without departing from the scope of the invention, which is intended to be limited only by the scope of the appended claims.

1. An electrical connector, comprising:
an electrical connector body having an upper wall and an oppositely disposed lower wall, a terminal cavity being defined between said upper and lower walls, said electrical connector body having an entry port communicating with said terminal cavity; and
at least one dual contact function spring contact terminal connected with said electrical connector body and disposed in said terminal cavity, each dual contact function spring contact terminal comprising an arm connected with one of said upper and lower walls, said arm originating at a primary nose located at said entry port, said primary nose comprising a substantially 180 degree bend in said arm, said arm comprising an initial arm portion connected to said primary nose, a primary spring connected to said initial arm portion, a contact portion connected to said primary spring, a secondary nose connected to said contact portion in opposite disposition relative to said primary spring, wherein said secondary nose comprises a substantially 180 degree bend in said arm, and a secondary spring connected to said secondary nose, wherein said secondary spring terminates at an arm terminus which abuts said one of said upper and lower walls;
wherein said initial arm portion is oriented parallel to an adjacent one of said upper and lower walls in spaced close proximal relation thereto;
wherein said secondary nose further comprises first and second nose segments, said first nose segment extending from said contact portion to said bend, said second nose segment extending from said bend to said secondary spring, wherein said first and second segments are configured to contact one another at a location other than at said bend when said secondary spring is deformed; and
wherein said primary and secondary springs are configured to provide resilient location of said contact portion of said arm independently of each other.

2. The connector of claim 1, further comprising a relief spring formed in said one of said upper and lower walls, wherein said arm terminus abuts said relief spring.

3. The connector of claim 1, we a first slot is centrally disposed in said primary spring.

4. The connector of claim 1, wherein said at least one dual contact function spring contact terminal comprises one said dual contact function spring contact terminal; wherein said electrical connector body further comprises a terminal contact connected with said electrical connector body, said terminal contact being located in said terminal cavity in opposingly disposed relation with respect to the contact portion of the arm of the dual contact function spring contact terminal.

5. The connector of claim 4, wherein said terminal contact comprises a second arm connected with the other of said upper and lower walls, said second arm originating at a second nose located at said entry port, said second nose comprising a substantially 180 degree bend in said second arm.

6. The connector of claim 5, further comprising a relief spring formed in said one of said upper and lower walls, wherein said arm terminus abuts said relief spring.

7. The connector of claim 6, wherein a first slot is centrally disposed in said primary spring.

8. The connector of claim 1, wherein said at least one dual contact function spring contact teal comprises an upper dual contact function spring contact terminal connected to said upper wall, and a lower upper dual contact function spring contact terminal connected to said lower wall.

9. The connector of claim 8, further comprising:
an upper relief spring formed in said upper wall, wherein an upper arm terminus of said upper dual contact function spring contact terminal abuts said upper relief spring; and
a lower relief spring formed in said lower wall, wherein a lower arm terminus of said lower dual contact function spring contact terminal abuts said lower relief spring.

10. The connector of claim 9, wherein an upper first slot is centrally disposed in the primary spring of said upper dual contact function spring contact terminal; and wherein a lower first slot is centrally disposed in the primary spring of said lower dual contact function spring contact terminal.

11. A dual contact function spring contact terminal for an electrical connector body, comprising:
an arm connected with the electrical connector body, said arm originating at a primary nose, said primary nose comprising a substantially 180 degree bend in said arm, said arm comprising:
an initial arm portion connected to said primary nose;
a primary spring connected to said initial arm portion;
a contact portion connected to said primary spring;
a secondary nose connected to said contact portion in opposite disposition relative to said primary spring, wherein said secondary nose comprises a substantially 180 degree bend in said arm; and
a secondary spring connected to said secondary nose, wherein said secondary spring terminates at an arm terminus which abuts the electrical connector body;
wherein said initial arm portion is oriented parallel to an adjacent one of said upper and lower walls in spaced close proximal relation thereto; wherein said secondary nose further comprises first and second nose segments, said first nose segment extending from said contact portion to said bend, said second nose segment extending from said bend to said secondary spring, wherein said first and second segments are configured to contact one another at a location other than at said bend when said secondary spring is deformed; and
wherein said primary and secondary springs are configured to provide resilient location of said contact portion of said arm independently of each other.

12. The terminal of claim 11, wherein a first slot is centrally disposed in said primary spring.
